(19) United States
(12) Patent Application Publication
(10) Pub. No.: US 2022/0284329 A1
(43) Pub. Date: Sep. 8, 2022

(54) METHOD OF OUTPUTTING EXPLANATORY INFORMATION AND INFORMATION PROCESSING APPARATUS

(71) Applicant: FUJITSU LIMITED, Kawasaki-shi (JP)

(72) Inventor: Shunichi WATANABE, Kawasaki (JP)

(73) Assignee: FUJITSU LIMITED, Kawasaki-shi (JP)

(21) Appl. No.: 17/581,993

(22) Filed: Jan. 24, 2022

(30) Foreign Application Priority Data
Mar. 3, 2021 (JP) 2021-033756

(51) Int. Cl. G06N 5/04; G06N 5/02

(52) U.S. Cl. CPC G06N 5/045; G06N 5/022

(57) ABSTRACT

A non-transitory computer-readable recording medium stores a program for causing a computer to execute a process, the process includes calculating a contribution degree of each of a plurality of pieces of data each including a plurality of variables, with respect to a prediction result that is output by a machine-learning model in response to input of the plurality of pieces of data, by using an explanatory model generated based on the prediction result and the plurality of pieces of data, selecting a specific variable from among the plurality of variables, determining specific data among the plurality of pieces of data based on a value of the specific variable of each of the plurality of pieces of data and the contribution degree of each of the plurality of pieces of data, and outputting the specific data as explanatory information of the prediction result.

### CROSS-REFERENCE TO RELATED APPLICATION

This application is based upon and claims the benefit of priority of the prior Japanese Patent Application No. 2021-033756, filed on Mar. 3, 2021, the entire contents of which are incorporated herein by reference.

### FIELD

The embodiment discussed herein is related to a method of outputting explanatory information and an information processing apparatus.

### BACKGROUND

A complex machine-learning prediction model with a central focus on deep learning (DL) has a high level of black box property, which is a large obstacle to actual operations in business.

In recent years, in a machine-learning model, explainable artificial intelligence (XAI) has been known as a technique to cause a process leading to a prediction result, an estimation result, or the like to be in a state explainable to a person. The explainable state may be referred to as a state in which the user is convinced by the explanation.

In XAI, for example, LIME and SHAP are known as tools for interpreting why, regarding a prediction of a certain sample, the machine-learning model has made the prediction.

As a related technique for clarifying what is considered important by the model of LIME, SHAP, or the like, a contribution degree calculation method in factor units is known.

In the contribution degree calculation method, a contribution degree to an output result of the model is calculated for each of a plurality of factors, and then a factor having a high contribution degree is presented.

FIG. 9 is a diagram illustrating an example of output by SHAP.

In the example illustrated in FIG. 9, respective contribution degrees (importance) of a plurality of factors to a certain output of a model is represented by a graph. In the example illustrated in FIG. 9, it may be understood that the factor “LSTAT” has contributed most to a prediction task.

Japanese Laid-open Patent Publication No. 2010-165166 and Japanese Laid-open Patent Publication No. 2019-82883 are disclosed as related art.

### SUMMARY

According to an aspect of the embodiment, a non-transitory computer-readable recording medium stores a program for causing a computer to execute a process, the process includes calculating a contribution degree of each of a plurality of pieces of data each including a plurality of variables, with respect to a prediction result that is output by a machine-learning model in response to input of the plurality of pieces of data, by using an explanatory model generated based on the prediction result and the plurality of pieces of data, selecting a specific variable from among the plurality of variables, determining specific data among the plurality of pieces of data based on a value of the specific variable of each of the plurality of pieces of data and the contribution degree of each of the plurality of pieces of data, and outputting the specific data as explanatory information of the prediction result.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration of an information processing apparatus according to an embodiment;

FIG. 2 is a diagram exemplifying a hardware configuration of an information processing apparatus according to an embodiment;

FIG. 3 is a diagram exemplifying input data in an information processing apparatus according to an embodiment;

FIG. 4 is a diagram exemplifying a user-oriented data input screen in an information processing apparatus according to an embodiment;

FIG. 5 is a diagram for describing a contribution degree generated by an interpretable model generator of an information processing apparatus according to an embodiment;

FIG. 6 is a diagram for describing a method of selecting a presentation edge in a case of categorical data in an information processing apparatus according to an embodiment;

FIG. 7 is a diagram for describing a method of selecting a presentation edge in a case of numerical data in an information processing apparatus according to an embodiment;

FIG. 8 is a flowchart for describing a process in an information processing apparatus according to an embodiment;

FIG. 9 is a diagram illustrating an example of output by SHAP; and

FIG. 10 is a diagram for describing conditions for achieving an explainable state in XAI.

### DESCRIPTION OF EMBODIMENT

In an actual XAI operation, it is rare to achieve a state explainable to all users (a state in which all users are convinced) by a single explanation.

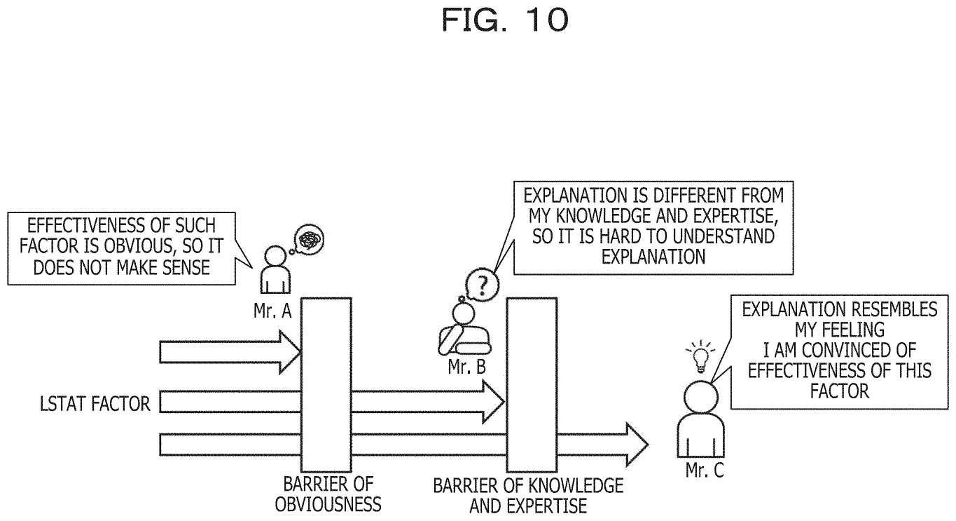

FIG. 10 is a diagram for describing conditions for achieving an explainable state in XAI.

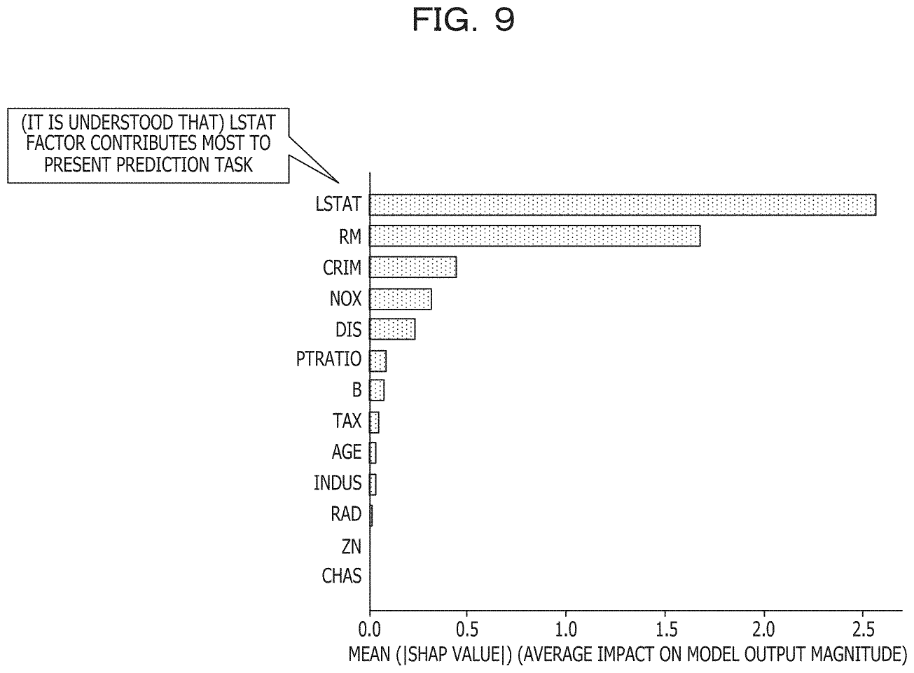

FIG. 10 illustrates how, in the example illustrated in FIG. 9, a plurality of users receives explanatory information telling that “the contribution degree of the factor “LSTAT” is highest with regard to a certain model output”.

It is assumed that “the contribution degree of the factor ‘LSTAT’ is high with regard to a certain model output” is obvious (relatively universal) for Mr. A. In this case, the above explanatory information is not useful to Mr. A at all. The explanatory information in XAI is desired to overcome the barrier of obviousness.

Meanwhile, it is assumed that the above explanatory information telling that “the contribution degree of the factor ‘LSTAT’ is highest with regard to a certain model output” is different from knowledge and expertise of Mr. B. In this case, Mr. B may not understand the above explanatory information. The explanatory information in XAI is also desired to overcome the barrier of knowledge and expertise.

Further, it is assumed that the above explanatory information telling that “the contribution degree of the factor ‘LSTAT’ is highest with regard to a certain model output” conforms to knowledge and expertise of Mr. C. In this case, the above explanatory information is accepted by Mr. C, as information that resembles his feeling and is convincing.

As described above, the explainable state is dependent on individual expertise and may vary from one user to another. Because of this, in the information presentation methods of related art in XAI, in a case where the explanatory information does not include an explanation or a factor that conforms to knowledge and expertise of each individual user, there is a risk that the explanatory information may not be in a state explainable to the user.

In the information presentation methods of related art in XAI, a contribution degree to an output result of a model is calculated for each data (variable) including a plurality of attributes, and then data with a high contribution degree is presented. However, since an attribute considered to be important at the time of interpretation depends on time and circumstances (including dependence on persons), an appropriate factor is not presented in some case.

Hereinafter, an embodiment will be described with reference to the drawings. However, the following embodiment is merely an example and does not intend to exclude application of various modification examples and techniques that are not explicitly described in the embodiment. For example, the present embodiment may be variously modified and implemented without departing from the spirit of the embodiment. Each drawing is not intended to indicate that only constituent elements illustrated in the drawing are provided; each drawing indicates that other functions and the like may be included.

### (A) Configuration

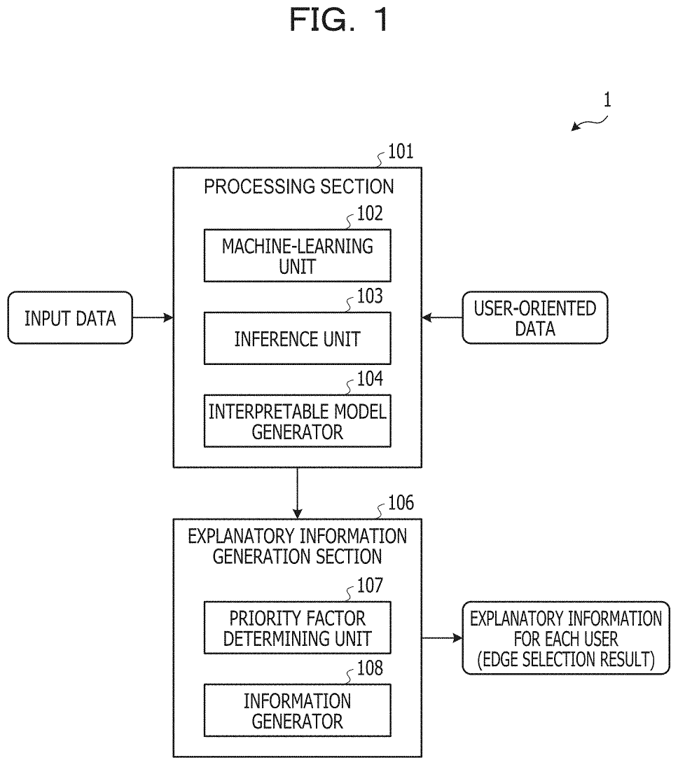

FIG. 1 is a diagram illustrating a configuration of an information processing apparatus 1 according to the embodiment.

The information processing apparatus 1 is an explanatory information output apparatus (computer) configured to implement XAI that performs inference on input data by using a machine-learning model, and presents, to a user, explanatory information indicating the grounds for the inference.

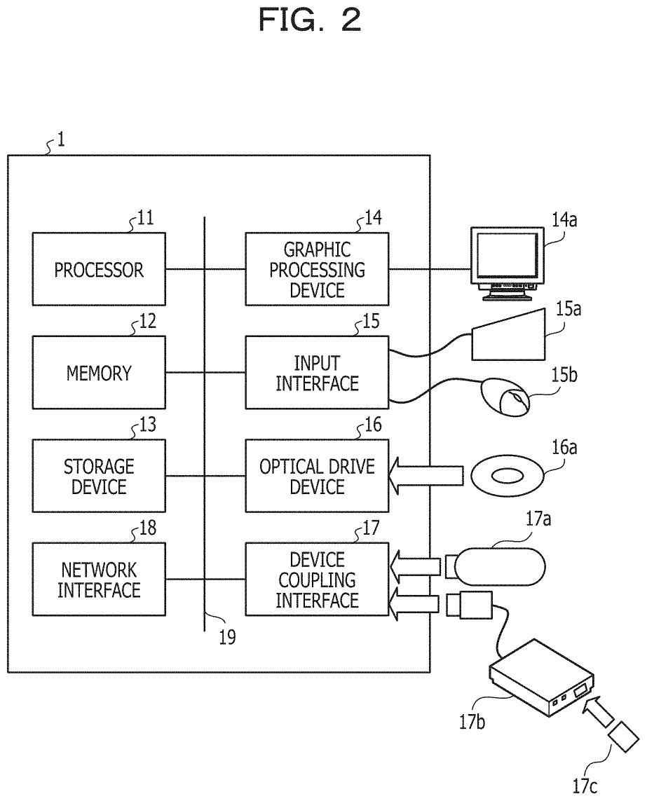

FIG. 2 is a diagram exemplifying a hardware configuration of the information processing apparatus 1 according to the embodiment.

The information processing apparatus 1 includes, for example, a processor 11, a memory 12, a storage device 13, a graphic processing device 14, an input interface 15, an optical drive device 16, a device coupling interface 17, and a network interface 18 as constituent elements. These constituent elements 11 to 18 are configured so as to be mutually communicable via a bus 19.

The processor 11 controls the overall information processing apparatus 1. The processor 11 may be a multiprocessor. The processor 11 may be any one of a central processing unit (CPU), a microprocessor unit (MPU), a digital signal processor (DSP), an application-specific integrated circuit (ASIC), a programmable logic device (PLD), and a field-programmable gate array (FPGA), for example. The processor 11 may be a combination of two or more types of elements of the CPU, the MPU, the DSP, the ASIC, the PLD, and the FPGA.

The processor 11 executes a control program (explanatory information output program (not illustrated)) for the information processing apparatus 1, thereby enabling functions as a processing section 101 and an explanatory information generation section 106 as exemplified in FIG. 1. Thus, the information processing apparatus 1 functions as an explanatory information output apparatus.

The information processing apparatus 1 enables function as the processing section 101 and the explanatory information generation section 106 by executing programs (the explanatory information output program and an operating system (OS) program) recorded in a non-transitory computer-readable recording medium, for example.

Programs in which contents of processing to be executed by the information processing apparatus 1 are described may be recorded in various recording media. For example, the programs to be executed by the information processing apparatus 1 may be stored in the storage device 13. The processor 11 loads at least part of the programs in the storage device 13 into the memory 12 and executes the loaded program.

The programs to be executed by the information processing apparatus 1 (processor 11) may be recorded in a non-transitory portable recording medium such as an optical disc 16a, a memory device 17a, and a memory card 17c. For example, the program stored in the portable recording medium may be executed after being installed in the storage device 13 by control from the processor 11. The processor 11 may read the program directly from the portable recording medium and execute the program.

The memory 12 is a storage memory including a read-only memory (ROM) and a random-access memory (RAM). The RAM of the memory 12 is used as a main storage device of the information processing apparatus 1. In the RAM, at least part of the programs to be executed by the processor 11 is temporarily stored. In the memory 12, various kinds of data desired for the processing by the processor 11 are stored.

The storage device 13 is a storage device, such as a hard disk drive (HDD), a solid-state drive (SSD), and a storage class memory (SCM), and stores various kinds of data. The storage device 13 is used as an auxiliary storage device of the information processing apparatus 1. In the storage device 13, the OS program, the control program, and various data are stored. The control program includes the explanatory information output program.

As the auxiliary storage device, a semiconductor storage device, such as the SCM and a flash memory, may be used. A plurality of storage devices 13 may be used to constitute redundant arrays of inexpensive disks (RAID).

The storage device 13 may store various data generated when the processing section 101 and the explanatory information generation section 106 execute the respective processes.

A monitor 14a is coupled to the graphic processing device 14. The graphic processing device 14 displays an image on a screen of the monitor 14a in accordance with an instruction from the processor 11. Examples of the monitor 14a include a display device with a cathode ray tube (CRT), and a liquid crystal display device.

A keyboard 15a and a mouse 15b are coupled to the input interface 15. The input interface 15 transmits signals transmitted from the keyboard 15a and the mouse 15b to the processor 11. The mouse 15b is an example of a pointing device, and other pointing devices may be used. Examples of the other pointing devices include a touch panel, a tablet, a touch pad, and a track ball.

The optical drive device 16 reads data recorded on the optical disc 16a by using laser light or the like. The optical disc 16a is a portable non-transitory recording medium in which data is recorded to be readable by light reflection. Examples of the optical disc 16a include a Digital Versatile Disc (DVD), a DVD-RAM, a compact disc read-only memory (CD-ROM), a compact disk-recordable (CD-R), and a compact disk-rewritable (CD-RW).

The device coupling interface 17 is a communication interface for coupling peripheral devices to the information processing apparatus 1. For example, the memory device 17a and a memory reader-writer 17b may be coupled to the device coupling interface 17. The memory device 17a is a non-transitory recording medium equipped with a function of communicating with the device coupling interface 17 and is, for example, a Universal Serial Bus (USB) memory. The memory reader-writer 17b writes data to the memory card 17c or reads data from the memory card 17c. The memory card 17c is a card-type non-transitory recording medium.

The network interface 18 is coupled to a network. The network interface 18 transmits and receives data via the network. Other information processing apparatuses, communication devices, or the like may be coupled to the network.

The information processing apparatus 1 exemplified in FIG. 1 includes the processing section 101 and the explanatory information generation section 106.

The processing section 101 receives input data and performs processing on the input data using a machine-learning model.

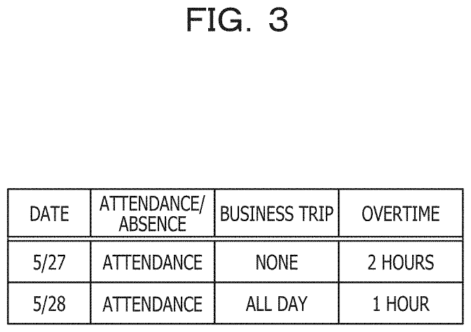

FIG. 3 is a diagram exemplifying input data in the information processing apparatus 1 according to the embodiment.

In the present embodiment, there will be exemplified and described a task that is carried out by the information processing apparatus 1, is used in the field of health and productivity management, and performs binary classification of whether leave of absence is taken (whether to take leave of absence) in the future based on attendance data by using a machine-learning model. For example, the attendance data of a prediction target person is input to the machine-learning model to predict whether the prediction target person takes leave of absence in the future.

Input data exemplified in FIG. 3 is tensor data indicating attendance data of an employee, and includes date, attendance/absence, presence or absence of business trip (business trip), and overtime hours (overtime).

In the input data exemplified in FIG. 3, a combination of date, attendance/absence, business trip, and overtime may be referred to as an edge. Variables (business trip, overtime) constituting an edge are called factors in some cases. An edge may be said to be a complex factor relationship.

The input data corresponds to a plurality of pieces of data (attendance data, edges) including a plurality of variables (factors: business trip, overtime).

User-oriented data is input to the processing section 101. The user-oriented data is information indicating the factors that the user considers (focses on) as factors for contributing to the prediction by the machine-learning model among a plurality of kinds of factors constituting the edge.

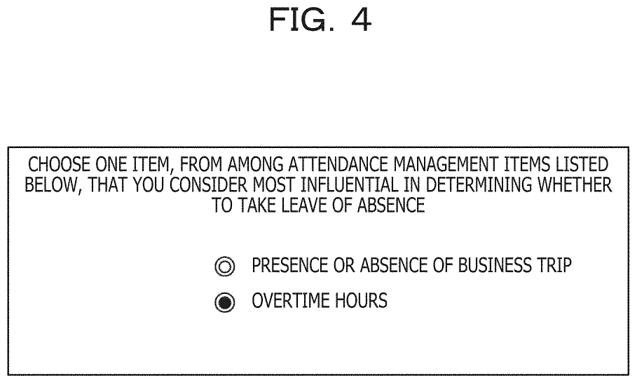

The user-oriented data may be input by the user in advance by using, for example, an input screen exemplified in FIG. 4.

FIG. 4 is a diagram exemplifying a user-oriented data input screen in the information processing apparatus 1 according to the embodiment.

The user-oriented data input screen is displayed on the monitor 14a or the like included in the information processing apparatus 1. The user inputs his/her user-oriented data via the user-oriented data input screen.

On the user-oriented data input screen exemplified in FIG. 4, a message of “choose one item, from among attendance management items listed below, that you consider most influential in determining whether to take leave of absence” is displayed. In addition, two choices of “presence or absence of business trip” and “overtime hours” are displayed thereon as a toggle switch. These “presence or absence of business trip” and “overtime hours” correspond to the factors of business trip and overtime, respectively.

For example, each of a plurality of users (Mr. A, Mr. B) belonging to a personnel department or a health promotion department of a company chooses, on the user-oriented data input screen, the item that each user considers to be most influential in determining whether to take leave of absence, and operates the keyboard 15a and the mouse 15b to input the choice.

The content chosen and input by the user is stored for each user in a predetermined storage area of the storage device 13, the memory 12, or the like, as user-oriented data. Hereinafter, the user-oriented data may be referred to as a priority factor. The user-oriented data corresponds to a priority variable in accordance with the user.

Although one factor is chosen as the user-oriented data in the example illustrated in FIG. 4, the embodiment is not limited thereto. The user may choose two or more factors as the user-oriented data, and the number of factors may be appropriately changed. The number of factors chosen as user-oriented data by the user may be referred to as the number of priority factors (N). The number of priority factors (N) may be optionally set in advance by the system manager or the like. In the present embodiment, for the sake of convenience, an example in which the number of priority factors N is one will be described.

As illustrated in FIG. 1, the processing section 101 includes a machine-learning unit 102, an inference unit 103, and an interpretable model generator 104.

The machine-learning unit 102 creates a machine-learning model by using a training data set. The training data set includes input data and correct answer data (teacher data). As the machine-learning model, for example, a support vector machine, a neural network, or a gradient boosting tree may be used.

In the following example, a case in which data that represents mainly tables and graphs by a tensor is taken as input data, and the machine-learning unit 102 creates a machine-learning model by using the algorithm of Deep Tensor (registered trademark), which is a well-known machine-learning technique, is exemplified and described.

The machine-learning unit 102 handles tables and graphs in a tensor format. Tables and graphs may be referred to as tensor data. The machine-learning unit 102 transforms the input data into a core tensor by tensor decomposition, inputs the core tensor to a neural network, and creates, by machine learning, a machine-learning model for outputting an inference result with respect to the input data.

The machine-learning unit 102 creates the machine-learning model by optimizing parameters used for the tensor decomposition and parameters of the neural network based on the training data. The machine-learning unit 102 uses, for example, a gradient descent method to update the parameters for the tensor decomposition and the parameters of the neural network in a direction of reducing a loss function that defines an error between correct answer data and an inference result of the machine-learning model with respect to the training data, thereby optimizing the parameters.

The neural network may be a hardware circuit or a virtual network by software that couples layers virtually built in a computer program by the processor 11.

The inference unit 103 performs inference by using the machine-learning model created by the machine-learning unit 102. The inference unit 103 inputs inference target tensor data to the machine-learning model, and obtains an inference result output from the machine-learning model.

To explain the inference result of the machine-learning model created by the machine-learning unit 102, the interpretable model generator 104 generates an interpretable model that locally approximates the machine-learning model as a model that easily explains the contribution of each variable included in the input data.

For example, the interpretable model generator 104 generates the interpretable model by using a known method of interpreting the grounds for prediction, such as UME or SHAP, regarding the prediction (inference) of the machine-learning model. For example, the interpretable model generator 104 may generate a linear regression model that locally approximates the machine-learning model, based on multiple regression analysis with respect to the inference result of the data to be explained and the inference result of neighborhood data of the data to be explained, where the inference results are obtained by performing inference using the machine-learning model. The neighborhood data is data similar to the data to be explained, and is data with a difference from the data to be explained being equal to or smaller than a threshold. The interpretable model generator 104 may determine data in which the similarity of the core tensor is greater than or equal to a threshold as the neighborhood data. The similarity may be defined by a distance between tensors (for example, a square error). It may be said that the interpretable model generator 104 generates the interpretable model based on the core tensor similarity by generating the linear regression model based on the core tensor of the data to be explained and the inference result thereof.

The interpretable model identifies a contribution degree of each variable included in the data to be explained to the inference result based on the parameters of the generated linear regression model. For example, the interpretable model generator 104 may generate the interpretable model based on the prediction result output by the machine-learning model in response to input of a plurality of pieces of data (attendance data, edges), each containing a plurality of variables (factors), and based on the plurality of pieces of data.

In this case, the interpretable model generator 104 may calculate the contribution degree for each edge based on the interpretable model. A linear regression model partial regression coefficient may be used as the contribution degree.

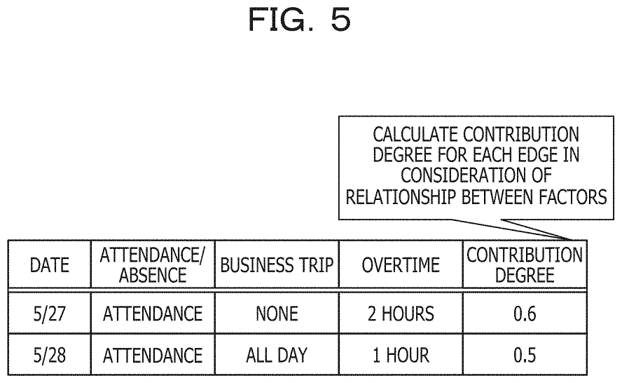

FIG. 5 is a diagram for describing the contribution degrees generated by the interpretable model generator 104 of the information processing apparatus 1 according to the embodiment.

In the example illustrated in FIG. 5, for example, the contribution degree “0.6” is set for the edge identified by the date May 27. Since the calculation of the contribution degree may be carried out with a known method, the description thereof will be omitted.

The explanatory information generation section 106 generates information indicating the grounds for the estimation performed on the input data by the processing section 101. The explanatory information generation section 106 generates explanatory information in such a manner that the user understands and is satisfied with the estimation made by the processing section 101 (explanatory information for each user).

In the information processing apparatus 1, considering that the user-oriented data varies from user to user based on knowledge and expertise of individual users, information (explanatory information) explaining the grounds for prediction (inference) by the machine-learning model in XAI is customized for each user and is presented. In the information processing apparatus 1, the explanatory information generation section 106 uses edges selected from the input data as the explanatory information for the user. For example, the explanatory information generation section 106 selects pieces of information (edges) that have contributed (led) to the estimation, and presents the selected information as explanatory information.

As illustrated in FIG. 1, the explanatory information generation section 106 includes a priority factor determining unit 107 and an information generator 108.

The priority factor determining unit 107 checks the priority factors (user-oriented data) of individual users. The priority factor determining unit 107 reads, from a predetermined storage area of the storage device 13, the memory 12, or the like, the user-oriented data having been input by the user via the user-oriented data input screen, and checks the contents thereof.

The information generator 108 generates, for each user, information (explanatory information) for explaining the grounds for the prediction (inference) by the machine-learning model in XAI.

For example, the information generator 108 uses, as explanatory information, an edge selected for each user from the plurality of pieces of input data. Hereinafter, an edge presented as explanatory information to the user may be referred to as a presentation edge. The presentation edge corresponds to the explanatory information of the prediction result output by the machine-learning model.

For example, the information generator 108 may select some of a plurality of edges constituting the input data as presentation edges and may present only the presentation edges as explanatory information to the user. The information generator 108 may select the plurality of edges as the presentation edges, set priorities for the plurality of presentation edges, and present the plurality of presentation edges to the user as the explanatory information while preferentially arranging the presentation edges in descending order of the priorities.

The information generator 108 selects the presentation edges based on the user-oriented data of each user.

At the time of selecting the presentation edge, the information generator 108 compares the contribution degree of each edge having been set by the interpretable model generator 104 with a preset contribution degree threshold. The information generator 108 selects the edge whose contribution degree is larger than the contribution degree threshold as a candidate for the presentation edge (presentation candidate edge).

The contribution degree threshold may be set by the system manager or the like in advance. The contribution degree threshold may be statistically determined based on the past contribution degrees associated with operations.

The information generator 108 generates the explanatory information by a method corresponding to the data format of the priority factor determined by the priority factor determining unit 107. The information generator 108 generates the presentation data by using different methods between a case where the data format of the priority factor is numerical data and a case where the data format thereof is categorical data.

The priority factor being numerical data is a factor represented by a numerical value, and corresponds to “overtime” represented by a numerical value of “overtime hours” in the present embodiment. On the other hand, the priority factor being categorical data is a factor that is represented by being classified into any category in a group of categories, and in the present embodiment, corresponds to “business trip” that is classified into any one of “all day (presence)” and “none”.

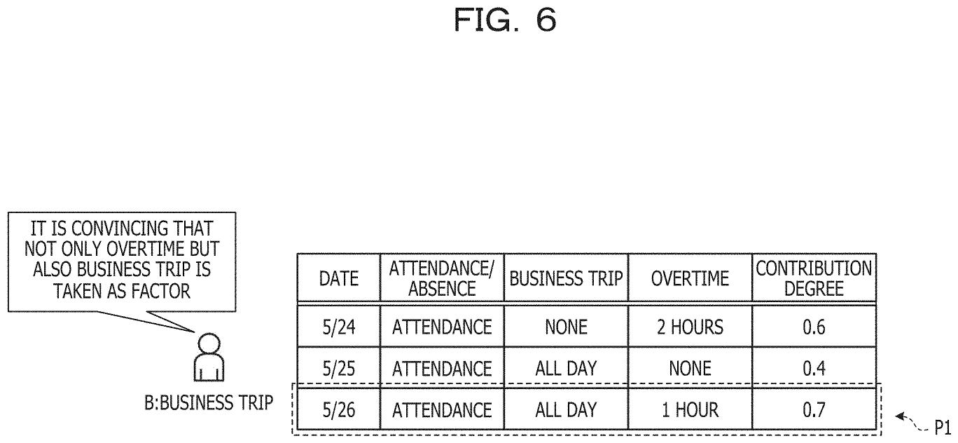

FIG. 6 is a diagram for describing a method of selecting a presentation edge in a case of categorical data in the information processing apparatus 1 according to the embodiment.

In the case where the data format of the priority factor is categorical data, the information generator 108 extracts at least one edge (presentation candidate edge) whose contribution degree is larger than the contribution degree threshold from the input data (edge group). Then, the information generator 108 identifies at least one edge (categorical data activated edge) where a value is generated (active) in the priority factor from among the at least one extracted presentation candidate edge. The presentation candidate edge corresponds to the presentation candidate data. The information generator 108 selects, as the presentation edge, the edge having the highest contribution degree from among the at least one extracted presentation candidate edge.

The information generator 108 selects a specific variable (the same variable as the priority factor) among the plurality of variables (factors), and determines specific data (presentation edge) among the plurality of edges, based on the value of the specific variable and the contribution degree of each of the plurality of pieces of data (edges).

For example, the information generator 108 determines, among the plurality of pieces of data (edge group), a plurality of pieces of presentation candidate data (presentation candidate edges) in which the value of the specific variable indicates the same specific category as the priority factor and the contribution degree is larger than the contribution degree threshold. Then, the information generator 108 determines data with the highest contribution degree as the presentation edge (specific data) among the plurality of presentation candidate edges.

In the following example, a case in which the contribution degree threshold is 0.45 is exemplified and described. It is assumed that the priority factor (user-oriented data) of Mr. B is “business trip”, which is categorical data.

In the example illustrated in FIG. 6, two edges with the dates of May 24 and May 26 correspond to presentation candidate edges whose contribution degrees are larger than the contribution degree threshold (0.45).

The information generator 108 selects the edge with the date of May 26 (see the reference sign P1) corresponding to the categorical data activated edge as the presentation edge from these two presentation candidate edges.

The information generator 108 may select the plurality of presentation edges of which the contribution degrees are larger than the contribution degree threshold, and may arrange the selected plurality of presentation edges in descending order of the contribution degrees to present them to the user.

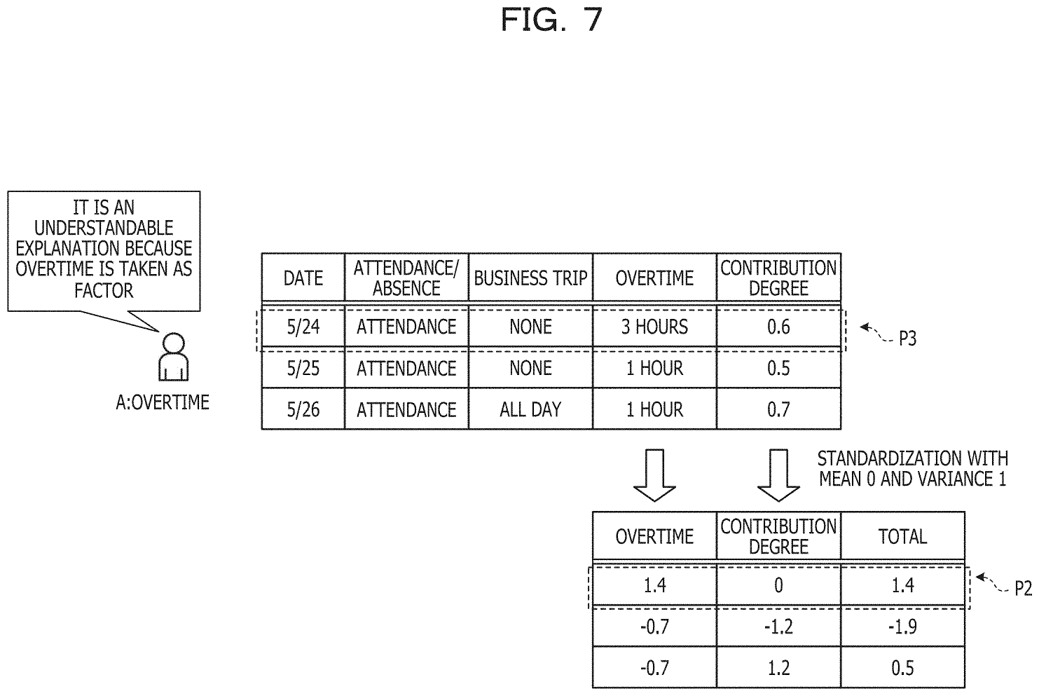

FIG. 7 is a diagram for describing a method of selecting a presentation edge in a case of numerical data in the information processing apparatus 1 according to the embodiment.

In the case where the data format of the priority factor is numerical data, the information generator 108 extracts at least one presentation candidate edge (presentation candidate data) whose contribution degree is larger than the contribution degree threshold from the input data (edge group). Then, the information generator 108 identifies at least one edge (numerical data activated edge) where a numerical value is generated (active) in the priority factor from among the at least one extracted presentation candidate edge. Subsequently, the information generator 108 selects the presentation edge by using two parameters of each data of the priority factor and each contribution degree thereof in each of the numerical data activated edges.

In the following example, it is assumed that the priority factor (user-oriented data) of Mr. A is “overtime”, which is numerical data.

In the example illustrated in FIG. 7, three edges with the dates of May 24, May 25, and May 26 all correspond to the presentation candidate edges whose contribution degree values are larger than the contribution degree threshold (0.45).

The information generator 108 acquires each overtime value and each contribution degree value of the priority factor from these three presentation candidate edges, respectively normalizes the value of the overtime and the value of the contribution degree of each edge, and calculates the sum (total value) of the normalized values of the overtime and the contribution degree for each edge.

In the example illustrated in FIG. 7, the information generator 108 transforms the values 3, 1, and 1 of the overtime on the dates May 24, May 25, and May 26 Into 1.4, −0.7, and −0.7, respectively, by performing standardization on each of the overtime values of the presentation candidate edges with the mean being 0 and the variance being 1.

The information generator 108 transforms the values 0.6, 0.5, and 0.7 of the contribution degrees on the dates May 24, May 25, and May 26 into 0, −1.2, and 1.2, respectively, by performing standardization on each of the contribution degree values of the presentation candidate edges with the mean being 0 and the variance being 1.

The information generator 108 may use, for example, affine transformation for the standardization (normalization) of each overtime value, each contribution degree value, and the like.

Then, the information generator 108 adds up the values of the overtime and the contribution degree after the standardization for each presentation candidate edge to obtain a sum. In the example illustrated in FIG. 7, for example, the values of the overtime and contribution degree after the standardization of the date May 24 are 1.4 and 0, respectively, and the total value thereof is 1.4.

The information generator 108 selects the presentation candidate edge (see the reference sign P2) of the date May 24 having the largest total value from among the three presentation candidate edges. The information generator 108 presents the selected presentation candidate edge to the user as the presentation edge (see the reference sign P3).

The information generator 108 may select the plurality of presentation candidate edges, arrange the selected plurality of presentation candidate edges in descending order of their total values, and present them to the user.

As described above, in the case where the data format of the priority factor is numerical data, the information generator 108 selects the presentation edge in consideration of not only the magnitude of the contribution degree but also the magnitude of the numerical data of the priority factor.

### (B) Operations

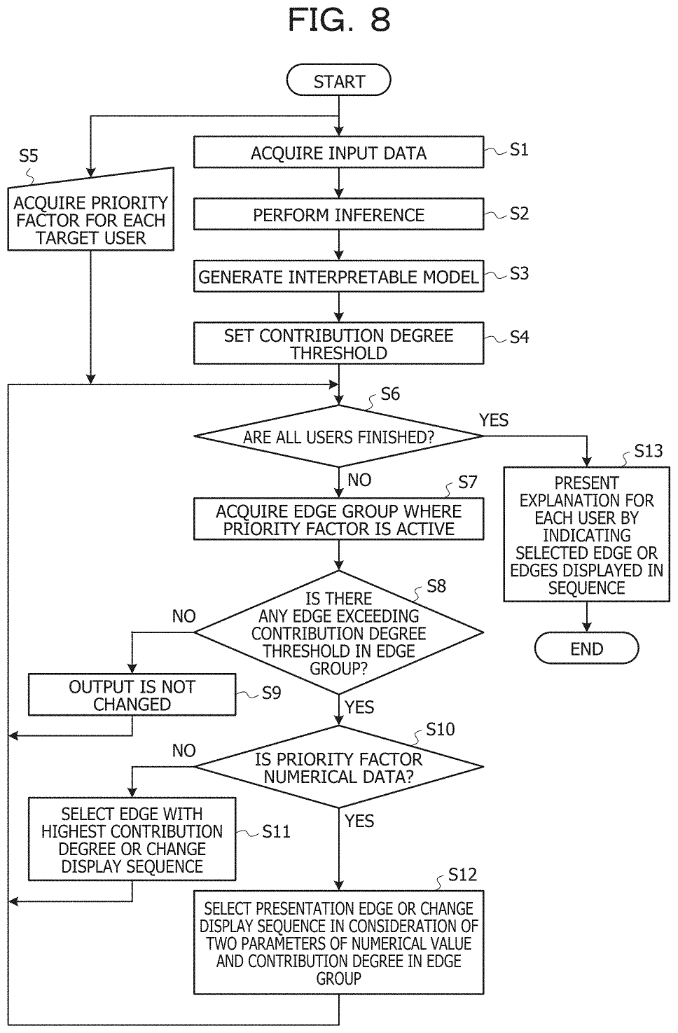

A process in the information processing apparatus 1, according to the embodiment configured as described above, will be described with reference to a flowchart (steps S1 to S13) illustrated in FIG. 8.

In step S1, the processing section 101 acquires input data, which is an inference target. In step S2, the inference unit 103 inputs the input data to the machine-learning model created by the machine-learning unit 102, and obtains an inference result output by the machine-learning model.

In step S3, the interpretable model generator 104 generates an interpretable model based on the core tensor (feature quantity) generated by the machine-learning unit 102.

The interpretable model generator 104 determines neighborhood data based on the similarity of the core tensor. The interpretable model generator 104 generates a linear regression model by using the neighborhood data and the inference result thereof. The interpretable model identifies a contribution degree of each variable included in the data to be explained to the inference result based on the parameters of the generated linear regression model. For example, the interpretable model generator 104 generates the interpretable model based on a prediction result output by the machine-learning model in response to input of a plurality of pieces of data (attendance data, edges) each containing a plurality of variables (factors) and based on the plurality of pieces of data.

In step S4, the processing section 101 sets, for example, a contribution degree threshold having been input or the like by the user in advance.

Each user of the information processing apparatus 1 performs input by using the user-oriented data input screen. In step S5, the processing section 101 acquires user-oriented data (priority factor) for each of a plurality of users (target users) who use the information processing apparatus 1.

In step S6, the information generator 108 checks whether explanatory information has been generated for all the users.

When the explanatory information has not been generated for all the users according to the check result (see the NO route of step S6), the process proceeds to step S7. Processing of steps S7 to S12 described below is carried out for each user.

In step S7, the priority factor determining unit 107 checks the priority factors of the user. The explanatory information generation section 106 acquires at least one edge (edge group) in which the priority factor of the user is active in the input data.

In step S8, the information generator 108 checks whether there exists any edge whose contribution degree exceeds the contribution degree threshold (presentation candidate edge) in the edge group acquired in step S7. When there is no edge whose contribution degree is larger than the contribution degree threshold according to the check result (see the NO route of step S8), the process proceeds to step S9. In step S9, the information generator 108 does not change the interpretable model output result generated by the interpretable model generator 104 using a known tool such as LIME, SHAP, or the like, and allows the above output result to be set as is as explanatory information. Then, the process returns to step S6.

When there is an edge of which the contribution degree is larger than the contribution degree threshold according to the check result in step S8 (see the YES route of step S8), the process proceeds to step S10. In step S10, the information generator 108 checks whether the data format of the priority factor is numerical data.

When the data format of the priority factor is numerical data according to the check result (see the YES route of step S10), the process proceeds to step S12.

In step S12, the information generator 108 selects a presentation edge or changes the display sequence of the plurality of presentation candidate edges based on two parameters of each numerical value of the priority factor and each contribution degree thereof in the plurality of presentation candidate edges. Then, the process returns to step S6.

When the data format of the priority factor is not numerical data according to the check result in step S10, for example, when the data format thereof is categorical data (see the NO route of step S10), the process proceeds to step S11.

In step S11, the information generator 108 selects, as a presentation edge, the edge having the highest contribution degree from among the plurality of presentation candidate edges. Alternatively, the information generator 108 changes the display sequence of the plurality of presentation candidate edges in descending order of their contribution degree values. Then, the process returns to step S6.

When the explanatory information has been generated for all the users according to the check result in step S6 (see the YES route of step S6), the process proceeds to step S13. In step S13, the explanatory information generation section 106 outputs, as the explanatory information, the presentation edge selected for each user or the plurality of presentation edges arranged in the sequence in accordance with the priority factor of the user. Then, the process ends.

### (C) Effects

As described above, according to the information processing apparatus 1 according to the present embodiment, the information generator 108 generates explanatory information (presentation edges) selected or arranged for each user, in accordance with the priority factor of each user. This may allow each user to easily understand and be satisfied with the prediction by the machine-learning model, and may improve the reliability of the entire XAI system.

Since the reliability of the entire XAI system is improved, it is possible to expand a width of the demand of the user for the XAI output.

When the priority factor of the user (user-oriented data) is categorical data, the information generator 108 extracts categorical data activated edges as presentation candidate edges, and selects the edge with the highest contribution degree from among the extracted presentation candidate edges as the presentation edge. Thus, the explanatory information to be presented to the user includes the edge reflecting the factor that the user considers to contribute to the prediction by the machine-learning model, thereby making it possible to generate explanatory information suited to the knowledge and expertise of the user. Accordingly, a state explainable to the user may be achieved.

When the priority factor of the user (user-oriented data) is numerical data, the information generator 108 extracts numerical data activated edges as presentation candidate edges, and selects the presentation edge in consideration of the two parameters of the value of the user priority factor and the contribution degree thereof from among the extracted presentation candidate edges. Thus, the explanatory information to be presented to the user includes the edge reflecting the factor that the user considers to contribute to the prediction by the machine-learning model, thereby making it possible to generate explanatory information suited to the knowledge and expertise of the user. Accordingly, a state explainable to the user may be achieved.

The information generator 108 acquires each overtime value and each contribution degree value of the priority factor from the plurality of presentation candidate edges, respectively normalizes the value of the overtime and the value of the contribution degree of each edge, and calculates the total sum of the normalized values of the overtime and the contribution degree for each edge. This makes it possible to easily select a presentation edge in consideration of two parameters of the value of the user priority factor and the contribution degree thereof.

### (D) Others

The present disclosure is not limited to the aforementioned embodiment and includes various modifications without departing from the gist of the disclosure.

For example, in the present embodiment, a task has been exemplified that is used in the field of heath and productivity management and performs binary classification of whether leave of absence is taken (whether to take leave of absence) in the future based on attendance data by using a machine-learning model, but the embodiment is not limited thereto, and various modifications may be made and implemented.

In the above embodiment, an example in which the number of priority factors N is one has been described, but the embodiment is not limited thereto, and the number of priority factors may be more than one.

In the embodiment described above, an example of the attendance data in which the input data is represented as a table has been described, but the embodiment is not limited thereto. The input data may have a format other than a table, such as a graph. The input data may be a type of data other than tables and graphs that may be handled as tensor data, and may be variously modified and used.

The above-described disclosure enables a person skilled in the art to implement and manufacture the present embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a process, the process comprising:
calculating a contribution degree of each of a plurality of pieces of data each including a plurality of variables, with respect to a prediction result that is output by a machine-learning model in response to input of the plurality of pieces of data, by using an explanatory model generated based on the prediction result and the plurality of pieces of data;
selecting a specific variable from among the plurality of variables;
determining specific data among the plurality of pieces of data based on a value of the specific variable of each of the plurality of pieces of data and the contribution degree of each of the plurality of pieces of data; and
outputting the specific data as explanatory information of the prediction result.

2. The non-transitory computer-readable recording medium according to claim 1, the process further comprising:
selecting the specific variable from among the plurality of variables based on a priority variable corresponding to a user.

3. The non-transitory computer-readable recording medium according to claim 1, the process further comprising:
in a case that the specific variable is numerical data, selecting a plurality of pieces of presentation candidate data each having the contribution degree larger than a predetermined threshold from among the plurality of pieces of data; and
determining the specific data based on the value of the specific variable and the contribution degree from among the plurality of pieces of presentation candidate data.

4. The non-transitory computer-readable recording medium according to claim 3, the process further comprising:
obtaining, for the plurality of pieces of presentation candidate data, a first value by normalizing the value of the specific variable and a second value by normalizing the contribution degree; and
determining, as the specific data, data in which a sum of the first value and the second value is largest among the plurality of pieces of presentation candidate data.

5. The non-transitory computer-readable recording medium according to claim 1, the process further comprising:
in a case that the specific variable is categorical data, selecting a plurality of pieces of presentation candidate data in which the value of the specific variable indicates a predetermined category and the contribution degree is larger than a predetermined threshold, from among the plurality of pieces of data; and
determining, as the specific data, data with a highest contribution degree from among the plurality of pieces of presentation candidate data.

6. A method of outputting explanatory information, the method comprising:
calculating, by a computer, a contribution degree of each of a plurality of pieces of data each including a plurality of variables, with respect to a prediction result that is output by a machine-learning model in response to input of the plurality of pieces of data, by using an explanatory model generated based on the prediction result and the plurality of pieces of data;
selecting a specific variable from among the plurality of variables;
determining specific data among the plurality of pieces of data based on a value of the specific variable of each of the plurality of pieces of data and the contribution degree of each of the plurality of pieces of data; and
outputting the specific data as explanatory information of the prediction result.

7. The method according to claim 6, further comprising:
selecting the specific variable from among the plurality of variables based on a priority variable corresponding to a user.

8. The method according to claim 6, further comprising:
in a case that the specific variable is numerical data, selecting a plurality of pieces of presentation candidate data each having the contribution degree larger than a predetermined threshold from among the plurality of pieces of data; and
determining the specific data based on the value of the specific variable and the contribution degree from among the plurality of pieces of presentation candidate data.

9. The method according to claim 8, further comprising:
obtaining, for the plurality of pieces of presentation candidate data, a first value by normalizing the value of the specific variable and a second value by normalizing the contribution degree; and
determining, as the specific data, data in which a sum of the first value and the second value is largest among the plurality of pieces of presentation candidate data.

10. The method according to claim 6, further comprising:
in a case that the specific variable is categorical data, selecting a plurality of pieces of presentation candidate data in which the value of the specific variable indicates a predetermined category and the contribution degree is larger than a predetermined threshold, from among the plurality of pieces of data; and
determining, as the specific data, data with a highest contribution degree from among the plurality of pieces of presentation candidate data.

11. An information processing apparatus, comprising:
a memory; and
a processor coupled to the memory and the processor configured to:
calculate a contribution degree of each of a plurality of pieces of data each including a plurality of variables, with respect to a prediction result that is output by a machine-learning model in response to input of the plurality of pieces of data, by using an explanatory model generated based on the prediction result and the plurality of pieces of data;
select a specific variable from among the plurality of variables;
determine specific data among the plurality of pieces of data based on a value of the specific variable of each of the plurality of pieces of data and the contribution degree of each of the plurality of pieces of data; and
output the specific data as explanatory information of the prediction result.

12. The information processing apparatus according to claim 11, wherein
the processor is further configured to:
select the specific variable from among the plurality of variables based on a priority variable selected by a user.

13. The information processing apparatus according to claim 11, wherein
the processor is further configured to:
in a case that the specific variable is numerical data, select a plurality of pieces of presentation candidate data each having the contribution degree larger than a predetermined threshold from among the plurality of pieces of data; and
determine the specific data based on the value of the specific variable and the contribution degree from among the plurality of pieces of presentation candidate data.

14. The information processing apparatus according to claim 13, wherein
the processor is further configured to:
obtain, for the plurality of pieces of presentation candidate data, a first value by normalizing the value of the specific variable and a second value by normalizing the contribution degree; and
determine, as the specific data, data in which a sum of the first value and the second value is largest among the plurality of pieces of presentation candidate data.

15. The information processing apparatus according to claim 11, wherein
the processor is further configured to:
in a case that the specific variable is categorical data, select a plurality of pieces of presentation candidate data in which the value of the specific variable indicates a predetermined category and the contribution degree is larger than a predetermined threshold, from among the plurality of pieces of data; and
determine, as the specific data, data with a highest contribution degree from among the plurality of pieces of presentation candidate data.
